(19) United States
(12) Patent Application Publication
(10) Pub. No.: US 2004/0143740 A1
(43) Pub. Date: Jul. 22, 2004

(54) Method of using hardware-type electronic signature in e-mail handling system

(76) Inventor: Hungchou Tsai, Jiji Jen (TW)

Correspondence Address: RABIN & BERDO, P.C., Suite 500, 1101 14th Street, N.W., Washington, DC, 20005, US

(21) Appl. No.: 10/347,589

(22) Filed: Jan. 22, 2003

(51) Int. Cl. H04L 9/00

(52) U.S. Cl. 713/176

(57) ABSTRACT

A method of using hardware-type electronic signature in e-mail handling system includes the steps of a) connecting a USB hardware element to a sender end system, using a serial number assigned to the USB hardware element to encode and produce a hardware-type electronic signature, and registering the produced hardware-type electronic signature at a receiver end system; b) using the hardware-type electronic signature at the sender end system to encode and format an original e-mail, so as to produce a packet e-mail, and transmitting the packet e-mail to a selected receiver; c) verifying the hardware-type electronic signature at a receiver end system on receipt of the packet e-mail; and d) decoding the received packet e-mail and reducing the same to the original e-mail when the hardware-type electronic signature has been verified as correct at the receiver end system.

### BACKGROUND OF THE INVENTION

The present invention relates to a method of using hardware-type electronic signature in e-mail handling system.

With the increasingly wide applications of computers and Internet, most correspondences among people are now implemented in the form of e-mail that is quick, simple, and economical. Computer users use e-mails to transfer not only general letters and documents, but also commercially valuable electronic files, such as patent documents between patent attorneys and inventors, contracts between buyers and sellers, and confidential documents between different companies. In the world of Internet, linkage can be made between two distantly separated locations within a few seconds through e-mail to share and transmit important electronic files. However, there are also people intentionally taking advantage of Internet to infringe on and steal other people's private and confidential data.

To prevent computer hackers from intercepting e-mails and illegally using messages or contents of documents attached to the e-mails, some users would use passwords in important documents attached to the e-mails, so that the documents are encrypted. After sending of e-mail having the encrypted documents attached thereto, the sender must inform the receiver about the password that encrypted particular documents or the password combination accepted by both sides, so that the receiver may use the password to decrypt the received documents.

While the above-described method of encryption protects the confidential documents attached to e-mails sent between the sender and the receiver, it has the following disadvantages:

1. Limited effectiveness of the password:

Since the password is agreed and certified by and between the sender and the receiver, it may be considered as a man-made code formed from combination of a group of symbols, numerals, or alphabets. A man-made code has many drawbacks. For example, the code may be easily illegally disclosed to or obtained by a third party. Therefore, it is necessary to frequently change the password to ensure the safety of the important documents attached to e-mails.

2. Incomplete protection against disclosure of e-mail:

While a password or other encryption means provides increased security of important file attached to e-mail, a network hacker may still intercept the subject and the message content of the e-mail. By reading the subject and the message content of the e-mail, it is possible to determine whether the attached file is commercially valuable or not before the hacker decides to intercept or damage the attached file.

3. Suitable only for person-to-person e-mail transmission:

As mentioned above, the sender of e-mail having encrypted file attached thereto must inform the receiver about the password to decrypt the file attached to the received e-mail. When there is more than one receiver, and the sender needs to increase the effectiveness of the password or there is a fixed combination of passwords between the sender and some receiver, then the sender must use different passwords to separately encrypt the file attached toe-mails sent to different receivers. Therefore, the method of simply using a password to encrypt the attached file is not suitable for one-to-many transaction that frequently occurs in general corporations.

### SUMMARY OF THE INVENTION

It is therefore a primary object of the present invention to provide a method of using hardware-type electronic signature in e-mail handling system to overcome the disadvantages existed in the conventional way of encrypting the file attached to e-mail. In the method of the present invention, a universal serial bus (USB) hardware element, due to a unique serial number assigned thereto and the advantageous portability thereof, is utilized as an electronic signature for the subject, message content, and attached file of each e-mail. The electronic signature also acts as a part of a key to form a scrambled code for the subject, the message content, and the attached file of the encrypted e-mail. Due to the portability of the hardware-type electronic signature, a user needs not to use a code at all. The user needs only to plug the USB hardware element into a computer system to download the e-mail and decrypt the subject, the message content, and the attached file of the received e-mail.

The method of using hardware-type electronic signature in e-mail handling system according to the present invention includes at least the following steps:

a) connecting a USB hardware element to a sender end system, using a serial number assigned to the USB hardware element to encode and produce a hardware-type electronic signature, and registering the produced hardware-type electronic signature at a receiver end system;

b) using the hardware-type electronic signature at the sender end system to encode and format an original e-mail, so as to produce a packet e-mail, and transmitting the packet e-mail to a selected receiver;

c) verifying the hardware-type electronic signature at a receiver end system on receipt of the packet e-mail; and

d) decoding the received packet e-mail and reducing the same to the original e-mail when the hardware-type electronic signature has been verified as correct at the receiver end system.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic conceptual diagram showing the method of using hardware-type electronic signature in e-mails handling system according to the present invention;

FIG. 2 is a conceptual diagram showing the production and sending of a USB electronic signature at the sender end;

FIG. 3 is a conceptual diagram showing the acceptance and registration of a sender's USB electronic signature at the receiver end;

FIG. 4 is a flowchart showing the steps for a sender to send out an e-mail using the method of the present invention;

FIG. 5 is a flowchart showing the steps for a receiver to receive an e-mail using the method of the present invention; and

FIG. 6 is an overall flowchart showing the steps for sending and receiving an e-mail using the method of the present invention.

### DETAILED DESCRIPTION OF THE PREFERRED EMBODIMENTS

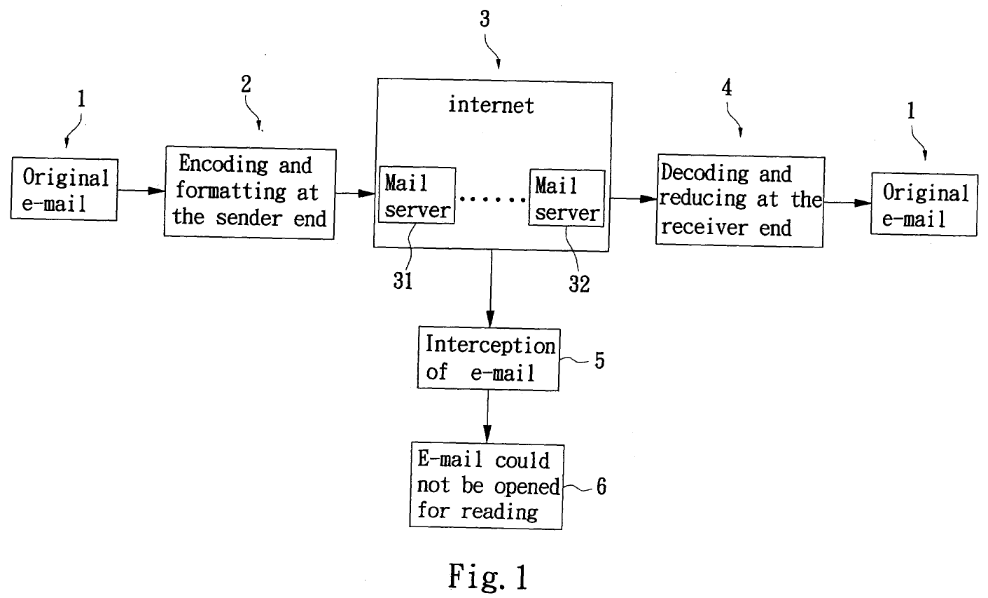

Please refer to FIG. 1 that is a schematic conceptual diagram showing the method of using hardware-type electronic signature in e-mails handling system according to the present invention. An original e-mail 1 is encoded and formatted at a sender end (block 2) and then sent to a remote mail server 31. The e-mail is then transmitted via Internet 3, which has a plurality of gateways and servers, to a remote mail server 32 at a receiver end. The encoded and formatted e-mail is downloaded from the remote mail server 32 at the receiver end before being decoded and reduced (block 4) to the original e-mail 1 that is readable by the receiver. In the event of an interception of the e-mail (block 5) by a network hacker during transmission of the e-mail, it would be impossible for the hacker to read the encoded and formatted e-mail (block 6).

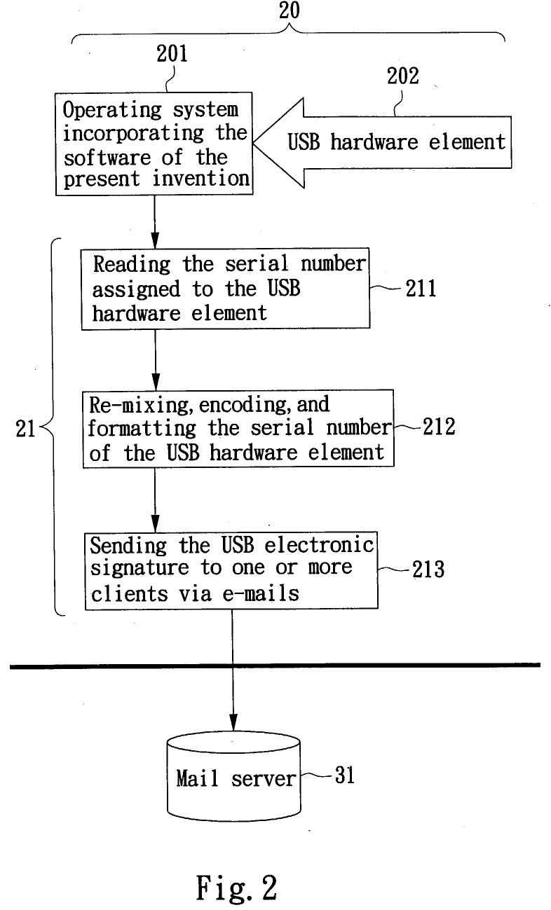

Please refer to FIG. 2 that is a conceptual diagram showing the production and sending of a USB electronic signature at the sender end. A system 20 at the sender end including a hardware-type electronic signature, that is, a USB electronic signature, combines a software operating system 201 and a USB hardware element 202. Procedures 21 for producing an electronic signature include reading a serial number of the USB hardware element (step 211), re-mixing and formatting the serial number to provide an electronic signature (step 212), and sending the USB electronic signature in the form of e-mail via the remote mail server 31 to one or more customers or receivers (step 213) for registration of the USB electronic signature at receiver end systems.

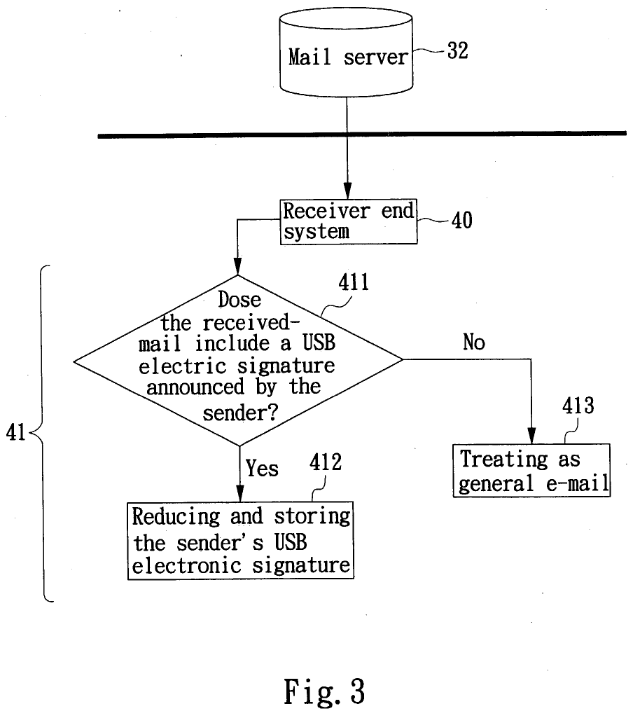

When the sender end system requests a receiver end system to register the hardware-type electronic signature, the receiver end system would, as a response to the request, identify and reduce the sender's e-mail address and hardware-type electronic signature, and stores these data in the receiver end system as a basis for verifying the sender's hardware-type electronic signature in the future. FIG. 3 is a conceptual diagram showing the acceptance and registration of the sender's USB electronic signature at the receiver end. The receiver end 40 downloads the e-mail from the remote mail server 32 and then proceeds with USB electronic signature registration procedures 41, including determination of whether the received e-mail includes a USB electronic signature announced by the sender (step 411). If yes, the sender's USB electronic signature is reduced and stored (step 412). If not, the received e-mail is treated as a general mail (step 413).

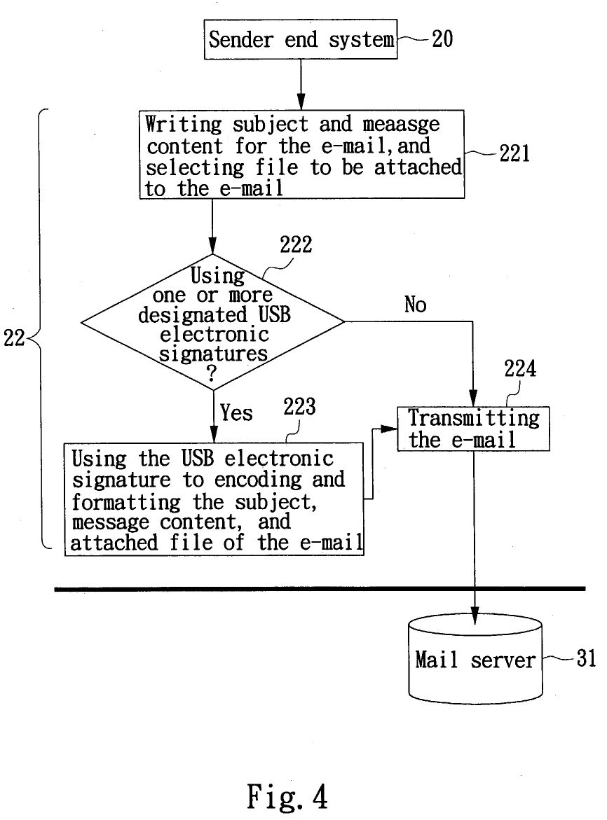

FIG. 4 shows a flowchart of sending e-mail at the sender end using the method of the present invention. To do so, the sender end system 20 proceeds with sending procedures 22 to transmit the e-mail to the remote mail server 31. The sending procedures 22 include writing subject and message content for thee-mail and selecting file to be attached to the e-mail (step 221), and deciding the use of one or more designated USB electronic signature (step 222). When there is more than one receiver, the method of the present invention allows the sender to individually encode and format the original e-mail based on each receiver's personalized hardware-type electronic signature. When it is selected to send the e-mail using the USB electronic signature, the subject and message content of the e-mail and the attached file are encoded and formatted using the USB electronic signature (step 223) to form a packet e-mail, which is then transmitted to the remote mail server 31 (step 224). The packet e-mail is compatible with general SMTP/POP3 format. If it is decided not to send the e-mail using the USB electronic signature, the e-mail is directly transmitted to the remote mail server 31 (step 224).

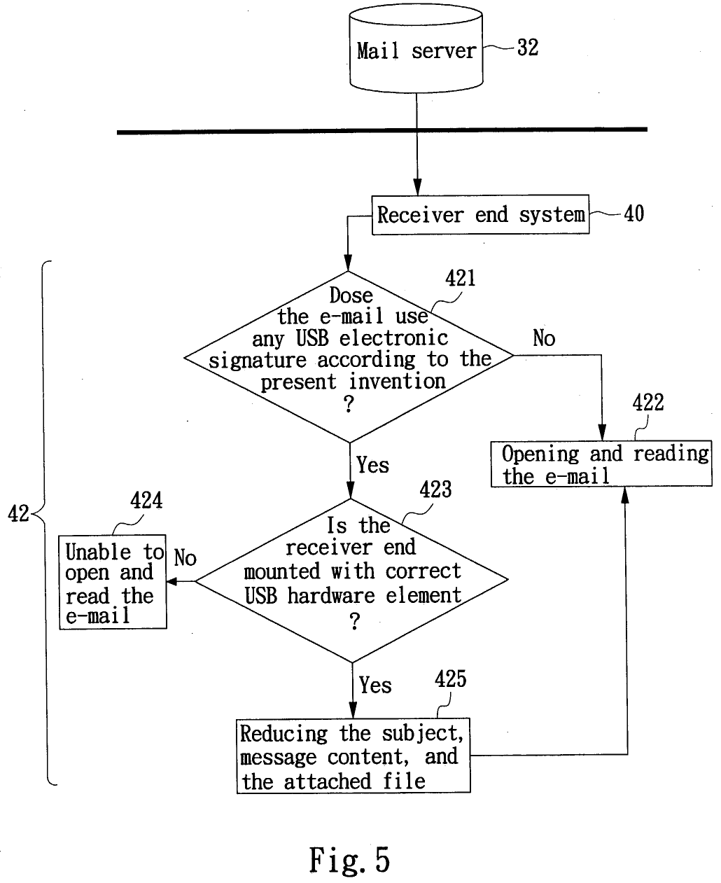

FIG. 5 shows a flowchart of receiving e-mail at the receiver end using the method of the present invention. To do so, the packet e-mail is downloaded from the remote mail server 32 to the receiver end system 40. At this point, the receiver end system 40 will proceed with verifying steps 22 to verify the hardware-type electronic signature. The verifying steps 22 include detecting the e-mail for use of any USB electronic signature as provided by the present invention (step 421). If no USB electronic signature is used, the e-mail is directly opened for reading (step 422). If a USB electronic signature is used, it is determined whether the receiver end has been mounted with a correct USB hardware element (step 423). If the receiver end has been mounted with a correct USB hardware element, the receiver end system would decode the packet e-mail and reduce the e-mail subject and message content and the attached file (step 425), and the e-mail is opened for reading (step 422). In the event the receiver end system makes mistakes during verification of the hardware-type electronic signature, the subject and message content of the e-mail would be scrambled codes and the e-mail could not be opened for reading (step 424). Therefore, it is impossible to read the subject and the message content of the received e-mail and to reduce the subject, the message content, and the attached file unless the receiver end is mounted with a USB hardware element having a correct serial number.

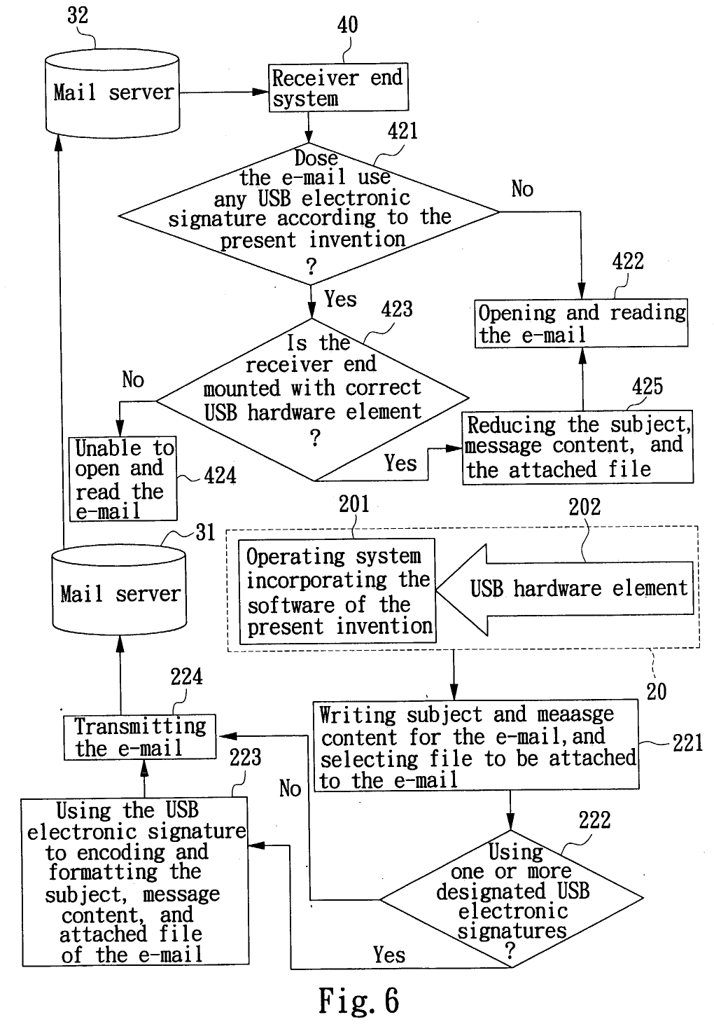

Please refer to FIG. 6 that is an overall flowchart showing the steps of receiving and sending e-mail using the method of the present invention. When the e-mail is downloaded from the remote mail server 32 to the receiver end system 40, the latter would first detect to confirm whether the received e-mail uses a USB electronic signature according to the present invention (step 421). If not, the received e-mail is treated as general e-mail and is directly opened for reading (step 422). If yes, it is further determined whether the receiver end is mounted with a correct USB hardware element (step 423). If yes, the receiver end system would decode the packet e-mail and reduces its subject and message content, and the attached file (step 425) and the received e-mail is opened for reading (step 422). In the event the receiver end system makes mistakes during verification of the hardware-type electronic signature, the subject and message content of the e-mail would be scrambled codes and the attached file could not be opened, that is, the e-mail could not be opened for reading (step 424). And, when it is desired to send a packet e-mail having subject, message content, and attached file being encoded and formatted using a USB electronic signature, the sender end system 20 must include corresponding software operating system 201 and USB hardware element 202, and produce a USB electronic signature for registration at the receiver end system 40. After the registration procedures are completed, the sender end may start writing the subject and message content of the e-mail and select the file to be attached to the e-mail (step 221). When it is decided to send the e-mail using the USB electronic signature (step 222), the sender end system 20 would encode and format the subject and message content of the e-mail and the file attached thereto using the USB electronic signature (step 223), so that a packet e-mail is produced. Then, the packet e-mail is transmitted to the remote mail server 31 (step 224). The packet e-mail is finally transmitted to the remote mail server 32 via linkage provided by Internet.

As described above, the method of using hardware-type electronic signature in e-mails handling system according to the present invention combines conveniently portable USB hardware element and software system. Wherein, a serial number of the USB hardware element is used to produce a unique electronic signature, which is then used to encode and format the subject, message content, and attached file of the e-mail, so that the hardware electronic signature may substitute for the conventional password. The sender uses the personalized hardware-type electronic signature registered at the receiver end to encode and format the original e-mail into a packet e-mail. In the case there are multiple receivers, the method of the present invention allows the sender to individually encode and format the original e-mail based on the personalized hardware-type electronic signature registered at each receiver before sending the packet e-mail, and the packet e-mail is compatible with general SMTP/POP3 system. When the packet e-mail reaches at the receiver end, it is impossible to read the subject and the message content of the received e-mail that are in a scrambled format and to open and read the file attached to the packet e-mail unless the receiver end system has an initially registered and recognized USB hardware element plugged thereinto to provide a correct serial number of the USB hardware element. Therefore, it is possible to ensure the privacy and integrity of e-mail sent using the hardware-type electronic signature according to the method of the present invention. Moreover, by using the conveniently portable USB hardware element as a key to substitute for the conventional password, a user needs not to memorize the password.

What is claimed is:

1. A method of using hardware-type electronic signature in e-mail handling system, comprising the steps of:
a) connecting a USB hardware element to a sender end system, using a serial number assigned to said USB hardware element to encode and produce a hardware-type electronic signature, and registering said produced hardware-type electronic signature at a receiver end system;
b) using said hardware-type electronic signature at said sender end system to encode and format an original e-mail, so as to produce a packet e-mail, and transmitting said packet e-mail to a selected receiver;
c) verifying said hardware-type electronic signature at said receiver end system on receipt of said packet e-mail; and
d) decoding said received packet e-mail and reducing the same to said original e-mail when said hardware-type electronic signature has been verified as correct at said receiver end system.

2. The method of using hardware-type electronic signature in e-mail handling system as claimed in claim 1, wherein the step of registering said hardware-type electronic signature by said sender end system at said receiver end system is implemented through e-mail.

3. The method of using hardware-type electronic signature in e-mail handling system as claimed in claim 1, wherein the step of registering said hardware-type electronic signature by said sender end system at said receiver end system further includes the step of identifying and reducing an e-mail address of said original e-mail and said hardware-type electronic signature at said receiver end system, and storing data about said identified and reduced e-mail address and hardware-type electronic signature in said receiver end system as a basis for verifying said hardware-type electronic signature in the future.

4. The method of using hardware-type electronic signature in e-mail handling system as claimed in claim 1, wherein the step of verifying said hardware-type electronic signature at said receiver end system further includes the step of ceasing the decoding and reducing of said packet e-mail when said receiver end system makes mistakes during verification of said hardware-type electronic signature.

5. The method of using hardware-type electronic signature in e-mail handling system as claimed in claim 1, wherein said e-mail has scrambled subject and message content when said receiver end system makes mistakes during verification of said hardware-type electronic signature.

6. The method of using hardware-type electronic signature in e-mail handling system as claimed in claim 1, wherein said e-mail has attached file that could not be opened for reading when said receiver end system makes mistakes during verification of said hardware-type electronic signature.
